(19) United States
(12) Patent Application Publication
(10) Pub. No.: US 2006/0130114 A1
(43) Pub. Date: Jun. 15, 2006

(54) Data server for interactive data broadcasting service and interactive data broadcasting service providing method using the same

(76) Inventors: Eun-Jung Kwon, Daejon (KR); O-Hyung Kwon, Daejon (KR); Soo-In Lee, Daejon (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/218,810

(22) Filed: Sep. 1, 2005

(30) Foreign Application Priority Data
Dec. 13, 2004 (KR) 10-2004-0105004

(51) Int. Cl. H04N 7/173; H04N 7/16

(52) U.S. Cl. 725/118; 725/105; 725/148

(57) ABSTRACT

Provided are a data server for interactive data broadcasting service and an interactive data broadcasting service providing method using the same. The present invention provides a data broadcasting service where users can participate in real-time by processing messages inputted through a return channel according to each content. The data server includes: a contents registering unit for registering a content of data broadcasting service in a file system; a storage for managing and storing signaling information of the registered content; and a data processing unit for defining an application message for the content supporting an interactive service, identifying the kind of the content by receiving the message inputted through a return channel, updating the content by analyzing the inputted message based on structural information of the message to perform interactive data broadcasting service in real-time.

### FIELD OF THE INVENTION

The present invention relates to a data server for an interactive data broadcasting service and an interactive data broadcasting service providing method; and, more particularly, to a data server for an interactive data broadcasting service that can update contents by analyzing subscriber data received through a return channel and broadcasting the updated contents in real-time, and a method for providing the interactive data broadcasting service by using the data server.

### DESCRIPTION OF RELATED ART

Services where users can participate are expected to increase as soon as a data broadcasting service is available in a digital cable broadcasting system. Since the digital cable broadcasting secures a return channel, which makes it possible to make interactive communication differently from terrestrial broadcasting and satellite broadcasting, it can be easily applied to the interactive data broadcasting service. Therefore, if a subscriber inputs subscriber data, i.e., a return channel message, into a set-top box by using a remote controller or other input devices with respect to a content supporting an interactive service, the information inputted by the subscriber is transmitted to a data server, i.e., a headend data broadcasting operation server. The content is updated in real-time through the transmitted subscriber data and, thus, the subscriber can receive the content updated in real-time. However, since the format of the message transmitted through a return channel is different according to each contents provider, it is not easy to reflect the subscriber data to the data broadcasting content updated in real-time.

If there is a message for data broadcasting which is defined and standardized according to service, the problem will be solved but this may restrict extensibility in providing a service.

For example, when a broadcasting contents provider provides a real-time auction program or a music program with a popularity vote through a data broadcasting service, a message with an intention of a subscriber, i.e., a return channel message, should be transmitted through the return channel, and a data server should be able to receive the message transmitted through the return channel and analyze each field of the message. If the message is a standardized data broadcasting message, it can be analyzed according to message defined in the standards. Thus, there is no problem in updating contents in real-time.

However, a message for providing a data broadcasting service is not defined in Korea and other countries. Even if it is defined, it can be restricted according to the kind of each service. Although the message has a general architecture, the message architecture can hardly be defined suitably to a particular service.

As described above, if the interactive data broadcasting service is provided in the digital broadcasting environment, subscribers would want to use a service that can reflect their intentions, instead of simply watching a television (TV).

At present, home shopping through the TV, which is not digital broadcasting, is generalized. However, the broadcasting method of home shopping cannot reflect the intention of a viewer directly through a TV screen while the viewer watches the TV, but the viewer communicates with a broadcasting provider through the Internet or a telephone. When the digital data broadcasting begins, broadcasting businesses will provide services that can increase their profits and the subscribers using the services will use the services as long as it is convenient to use them, although it takes cost. Therefore, the subscribers will participate in broadcasting services actively.

Accordingly, the contents providers produce a variety of applications to provide the data broadcasting service, and the broadcasting businesses broadcast the applications to users. The contents can be produced based on Application Program Interface (API) and contents formats, but application messages of applications that form contents can be different according to contents producers.

Therefore, since the subscriber data transmitted from the set-top box to the data server through a return channel are different according to contents, if the data server receiving the message transmitted through the return channel is not capable of processing the message for each content, the real-time interactive data broadcasting service is hardly provided.

### SUMMARY OF THE INVENTION

It is, therefore, an object of the present invention to provide a data server for an interactive data broadcasting service that can provide a data broadcasting service where subscribers can participate in real-time by processing a message inputted through a return channel according to each content, and an interactive data broadcasting service providing method using the same.

Other objects and advantages of the present invention can be understood by the following description of embodiments. It is apparent that the objects and advantages of the present invention can be embodied by the means as claimed and combinations thereof.

In accordance with an aspect of the present invention, there is provided a data server for an interactive data broadcasting service, which includes: a contents registering unit for registering a content of data broadcasting service in a file system; a storage for managing and storing signaling information of the registered content; and a data processing unit for defining an application message for the content supporting an interactive service, identifying the kind of the content by receiving the message inputted through a return channel, updating the content by analyzing the inputted message based on structural information of the message to perform interactive data broadcasting service in real-time.

In accordance with another aspect of the present invention, there is provided a method for providing an interactive data broadcasting service, which includes the steps of: a) registering a content of a data broadcasting service in a file system upon a request from an operator; b) storing signaling information on the content in a database; c) informing a data server to register the content supporting the interactive data broadcasting service; d) registering definition of a return channel message in the data server; e) defining the return channel message to satisfy transmission protocol and be encoded; f) receiving a file structure and contents of the content from a subscriber device; g) transmitting subscriber data reflecting intention of a subscriber through the return channel; and h) updating the content by receiving and analyzing the return channel message transmitted from each subscriber on a field basis.

### BRIEF DESCRIPTION OF THE DRAWINGS

The above and other objects and features of the present invention will become apparent from the following description of the preferred embodiments given in conjunction with the accompanying drawings, in which:

FIG. 1 is a block diagram showing a digital cable broadcasting system to which the present invention is applied;

FIG. 2 is a block diagram illustrating a digital cable broadcasting system connected with a data server for interactive data broadcasting service in accordance with an embodiment of the present invention;

FIG. 3 is a diagram describing a network interface in the digital cable broadcasting system to which the present invention is applied;

FIG. 4 is a diagram illustrating a relationship between messages in a Digital Storage Media-Command and Control (DSM-CC) protocol;

FIG. 5A is a diagram showing a Download Service Initiate (DSI) message in the DSM-CC protocol;

FIG. 5B is a diagram describing a Download Information Indication (DII) message in the DSM-CC protocol;

FIG. 5D is a diagram illustrating a BIOP:ServiceGateway object message in the DSM-CC protocol;

FIG. 5E is a diagram showing a BIOP:Directory object message in the DSM-CC protocol;

FIG. 5F is a diagram describing a BIOP:File object message in the DSM-CC protocol;

FIG. 6 is syntax for analyzing a message in an application layer in accordance with the present invention; arid

FIG. 7 is a flowchart describing a process of updating a content in real-time in the interactive data broadcasting service in accordance with an embodiment of the present invention.

### DETAILED DESCRIPTION OF THE INVENTION

Other objects and aspects of the invention will become apparent from the following description of the embodiments with reference to the accompanying drawings, which is set forth hereinafter.

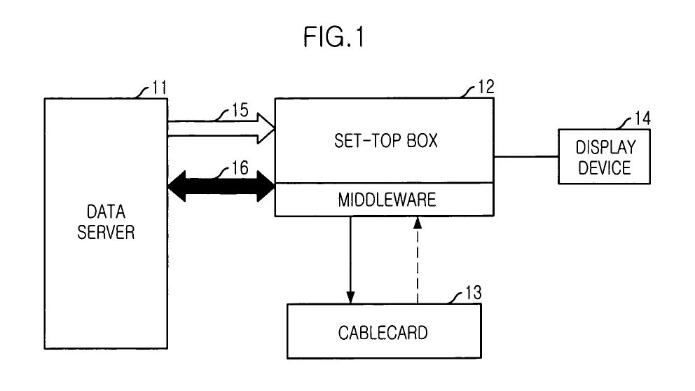

FIG. 1 is a block diagram showing a digital cable broadcasting system to which the present invention is applied.

As shown in FIG. 1, the digital cable broadcasting system includes a data server 11, which is also referred to as a data broadcasting operation server, an in-band channel network 15, an out-of-band channel network 16, a set-top box 12, a CableCard 13, a display device 14, e.g., television (TV).

The data server 11 includes audio/video/data encoding systems, a subscriber management system, a restrictive reception system, a server for providing an interactive data broadcasting service, and a system for forming the systems with broadcasting signals. The in-band channel network 15 transmits broadcasting signals. The out-of-band channel network 16 provides additional information and control information, other than the broadcasting signals. The set-top box 12 is provided with a middleware capable of transmitting and receiving broadcasting signals and out-of-band information. The CableCard 13 analyzes data received through an out-of-band channel or restrictive reception data. The display device 14 shows a broadcasting program and an application program of the set-top box 12.

In particular, the data server 11 providing the interactive data broadcasting service performs functions of managing contents, signaling contents application, encoding contents based on a Digital Storage Media-Command and Control (DSM-CC) transmission protocol, and providing the interactive data broadcasting service in real-time by analyzing subscriber data inputted through a return channel.

In the digital cable broadcasting, data broadcasting contents should follow the Open Cable Application Platform Specification (OCAP), and they should conform to the DSM-CC protocol defined in the OCAP to be transmitted in the form of a Moving Picture Experts Group (MPEG) 2-Transmit Stream (TS).

Meanwhile, the set-top box 12 receives the MPEG 2-TS packets and decodes them. Then, it executes a corresponding data broadcasting content and transmits a message with an intention of a subscriber inputted from an input device to the data server 11 according to the characteristics of the content.

In the broadcasting system environment, the data server 11 updates the content by analyzing the subscriber data transmitted though an out-of-band return data channel (OOB RDC), and services the updated content in real-time.

Also, the data server 11 makes the set-top box 12, which is a device on a subscriber's part, provide a real-time data broadcasting service with respect to the contents provided by a contents provider without an additional device.

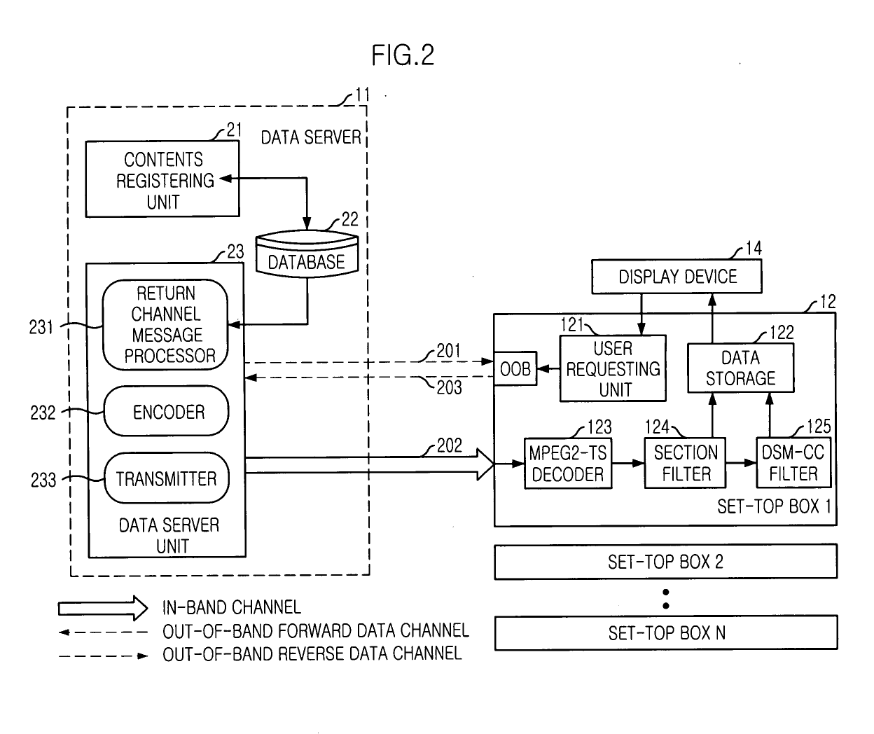

FIG. 2 is a block diagram illustrating a digital cable broadcasting system connected with a data server for interactive data broadcasting service in accordance with an embodiment of the present invention.

As illustrated in FIG. 2, the data server 11 for the interactive data broadcasting service, which is suggested in the present invention, includes a contents registering unit 21 for registering a content of a data broadcasting service in a file system, a database 22 for managing and storing signaling information of the content, and a data server unit 23. The data server unit 23 defines an application message for a content supporting an interactive service in a return channel message processor 231, identifies the kind of the content by receiving the message inputted through the return channel, updates the content by analyzing the inputted message based on structural information of the message, and implements the interactive data broadcasting in real-time.

Application that forms a data broadcasting content in the digital cable broadcasting is categorized as bound application, which is transmitted through an in-band channel 202, and unbound application, which is transmitted through an out-of-band channel 201.

A content including application is encoded into object carousel, data carousel, and MPEG2-TS packets and transmitted through the in-band channel 202. Signaling information of bound application is transmitted through the in-band channel 202, and signaling information of unbound application is transmitted through the out-of-band channel 201. The object carousel, which is the first step for encoding a content in conformity to a transmission protocol, produces a content registered in a file system on a basis of object messages, e.g., Dictionary, File, Stream, StreamEvent, and ServiceGateWay object message. The objects are formed into modules according to the data carousel and divided into download data blocks (DDBs). The DDB messages are encoded into DSM-CC sections along with download service initiate (DSI) and download information indication (DII), which are control informations for downloading DDBs from a set-top box, and positioned in the payloads of the MPEG2-TS packets.

As shown above, the content is encoded in an encoder 232 of the data server unit 23 and transmitted to a remultiplexer by a transmitter 233. Then, it goes through a modulator and it is transmitted to the set-top box 12 through a cable network 201.

In order to decode the received message in the set-top box 12, a program specific information (PSI) table is decoded in the first place. This makes it possible to decode data broadcasting stream corresponding to an elementary stream PID which is defined based on the descriptors of a PMT table among the PSI table.

MPEG2 Private Section data and the DSM-CC section data, which are loaded on the payload through an MPEG2-TS decoder 123, are filtered in a DSM-CC filter 124 based on a table_id value. Thus, modules, DSI and DII can be formed out of the DSM-CC section data according to data carousel, and a content can be formed in a file system structure from the modules on an object basis according to an object key defined in the object carousel. A DSM-CC private section is analyzed into data carousel and object carousel through a DSM-CC filter 125 and the analyzed data broadcasting application and content is transferred to a data storage 122.

The data stored in the data storage 122, which are finally analyzed objects, can be executed by a middleware of the set-top box 12. Of course, the received application and content are executed in consideration of execution priority order of applications which have received application signaling information.

Also, if the transmitted application is a TV broadcasting program broadcasted in real-time by reflecting the input by a subscriber, the input data inputted by the subscriber through a display device 14 are formed into data that can be analyzed in an application server providing the interactive service through a user requesting unit 121 and transmitted through an out-of-band reverse data channel 203.

As described above, the content is encoded into the DSM-CC object carousel, the DSM-CC data carousel, and the MPEG2-TS packets.

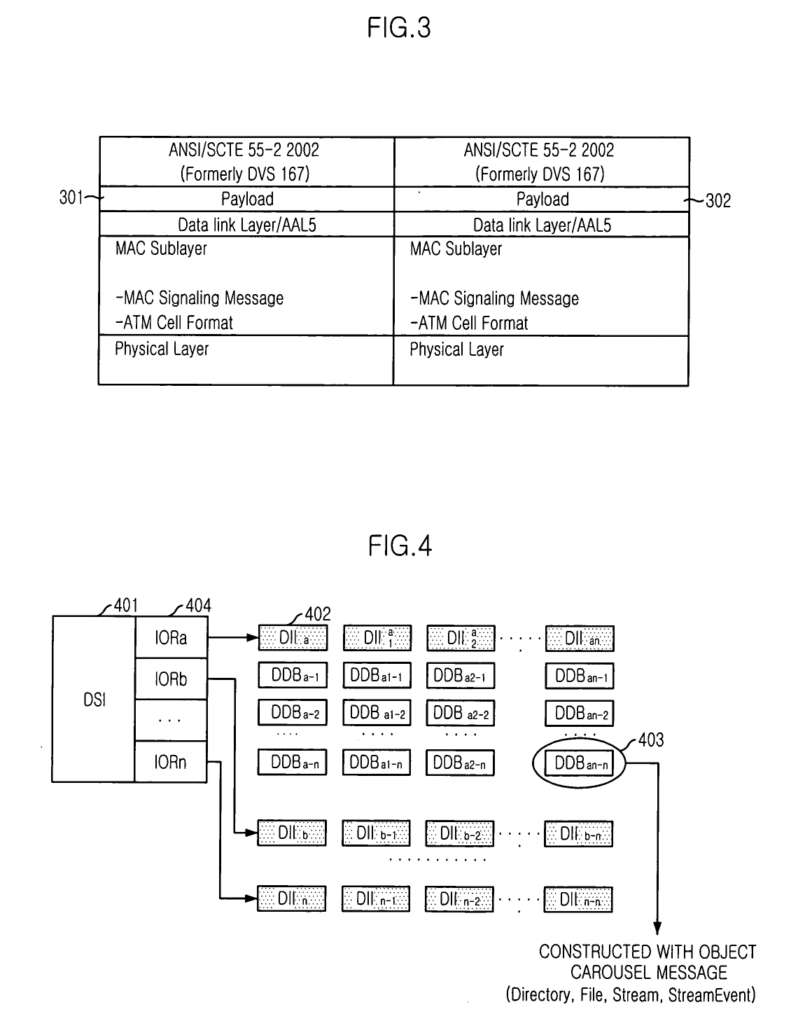

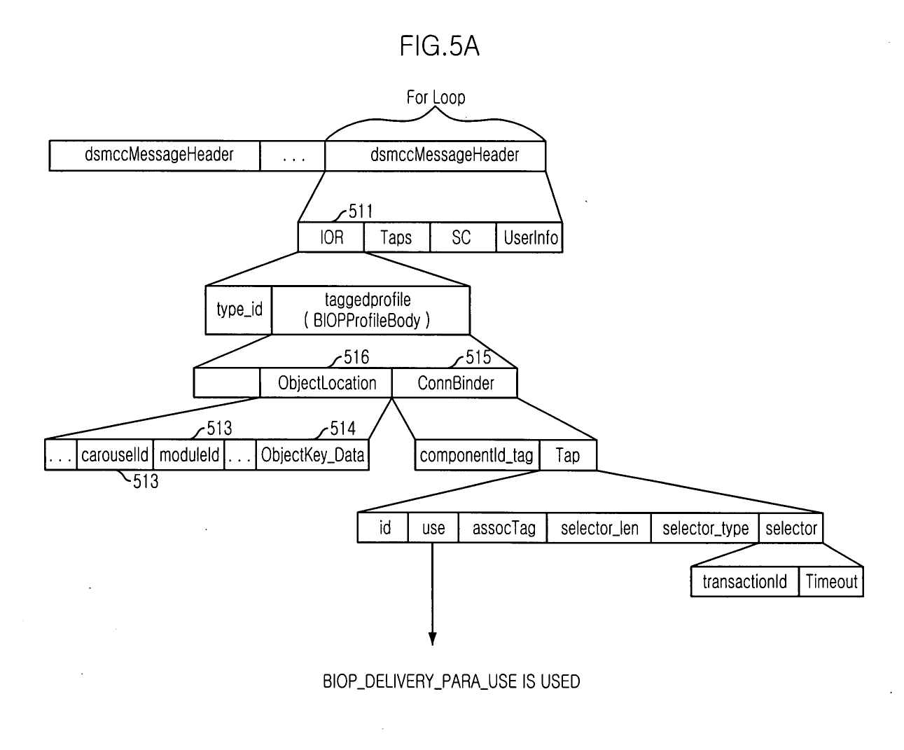

FIG. 3 is a diagram describing a network interface in the digital cable broadcasting system to which the present invention is applied. FIG. 4 presents correlation between messages which are needed to encode a content based on the DSM-CC protocol.

FIG. 4 is a diagram illustrating a relationship between messages in the DSM-CC protocol. As illustrated, when it is assumed that grouped objects transmitted to one carousel exist in the same service domain, the objects can be formed into modules, each having a maximum size of 64 K. The modules are divided into DDB 403 messages and loaded on the payloads of a DSM-CC section.

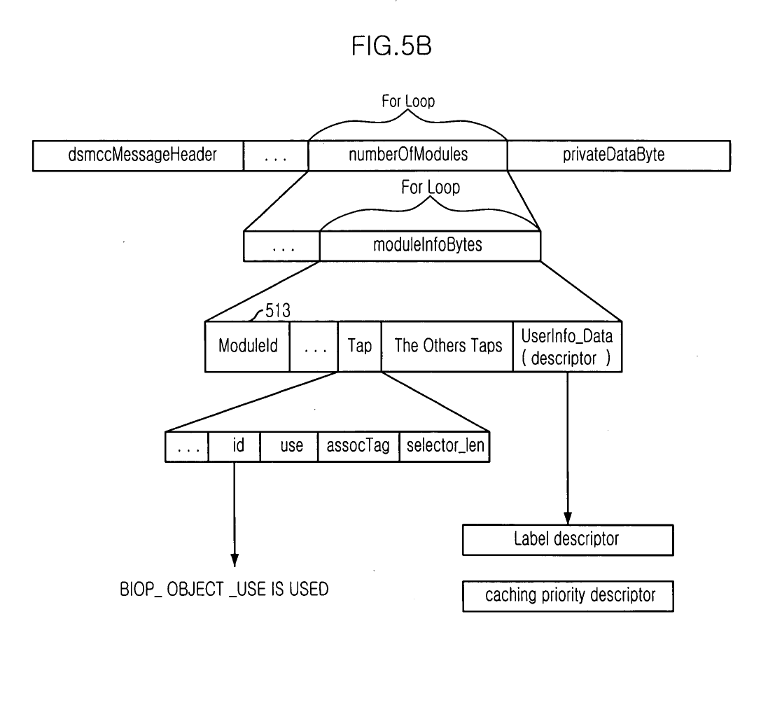

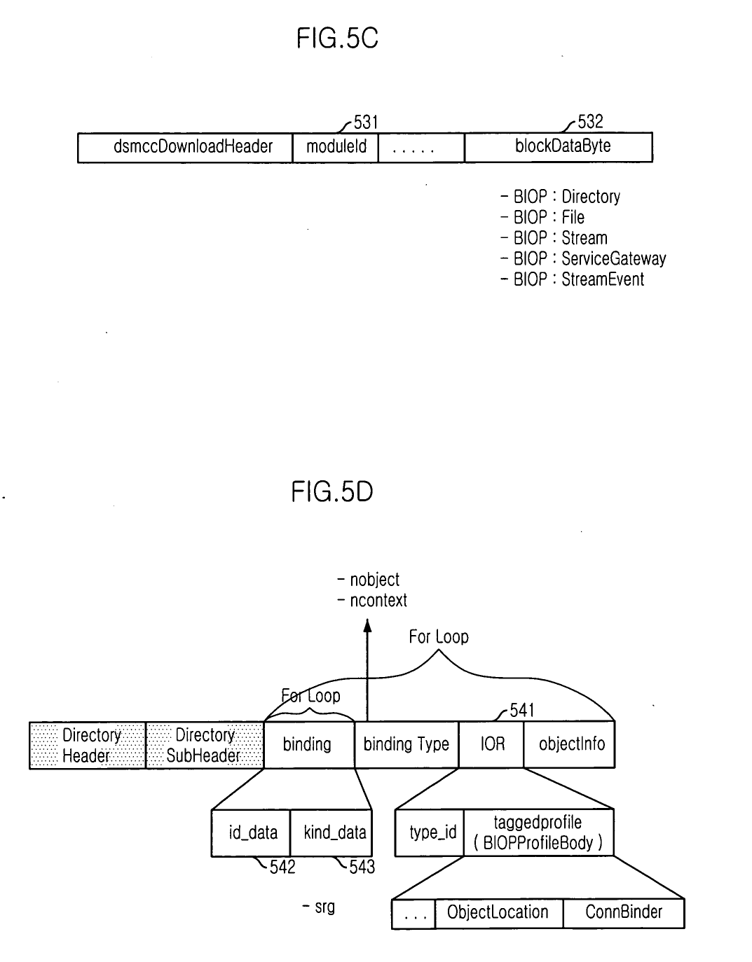

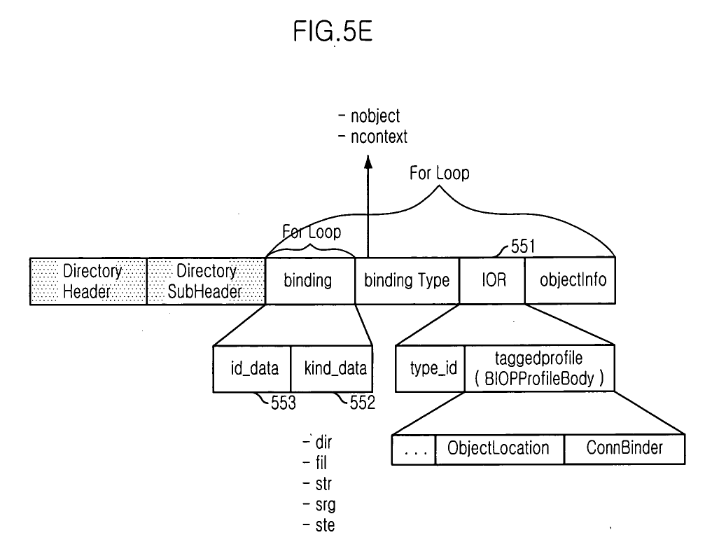

If the content is larger than 64K in size, there are more than two modules. Accordingly, a Download Service Initiate (DSI) 401, an IOR, and the DII 402 exist in proportion to the number of the modules. The objects loaded on the DDB 403 include a ‘ServiceGateWay object of FIG. 5D’ defined in the object carousel, a ‘Directory object of FIG. 5E,’ a ‘File object of FIG. 5F,’ ‘Stream object,’ and ‘StreamEvent object.’

The DSI message is formed as shown in FIG. 5A and it is related to the DII of FIG. 5B through a moduleId 513. Also, the carouselId 512 is the same among the contents of the same service domain.

In short, although there are a plurality of modules with respect to a content, the carouselId 512 of the modules are all the same. Also, the objects that form the content can be identified based on identifiers, which include the carouselId 512, the moduleId 513, and an ObjectKey_Data 514 that are shown in FIG. 5A.

The DII message has a structure as shown in FIG. 5B, and it presents relation with the DDB message of FIG. 5C having an object message through the moduleId 521.

The moduleId 531 of the DDB shown in FIG. 5C is related to the DII message corresponding to the moduleId 521 of FIG. 5B. A blockDataByte 532 of FIG. 5C carries an object message of a content generated in the middle of object carousel.

The object message includes a ServiceGateWay object message of FIG. 5D showing a top object in the service domain, a Directory object message of FIG. 5E representing directory information of the content, a File object message of FIG. 5F representing file information, and Stream object message and StreamEvent object messages.

A bining information field of FIGS. 5D and 5E represents id_data of an object included in the directory. The kind of the object can be identified from a kind_data field. That is, the id_data 542 of FIG. 5D can represent binding information by representing the id_data of a low-ranked directory object of FIGS. 4 to 5, or object_data 461 of a file object of FIGS. 4 to 6.

As described above, a user can use the interactive data broadcasting service through the return channel, as the data server transmits contents based on the transmission protocol of the data broadcasting service communicates with the set-top box.

In order to be operated as described above, a return channel message processor 231 of the data server unit 23 of the data server 11 updates the contents by analyzing the message transmitted through the return channel, which is received based on predefined contents specific application messages.

Hereafter, the operation of the digital cable broadcasting system connected with the data server 11 having the above structure for the interactive data broadcasting service will be described in detail.

First, as described above, the objects forming a content can be identified from the carouselId 512, moduleId 513, and ObjectKey_Data 514. Paying attention to the principle, a contents registering unit 21 of the data server 11 for the interactive data broadcasting service and a return channel message processor 231 of the data server unit 23 process the return channel message automatically.

An operator registers a content in a file system. The operator stores signaling information of the content in the database 22 and, when the content supports the interactive data broadcasting service, it notifies the registration of the content to the data server unit 23.

Accordingly, the data server unit 23 defines a specific application message for the content supporting the interactive data broadcasting service in the return channel message processor 231. The content is identified from the unique value of application that forms the content.

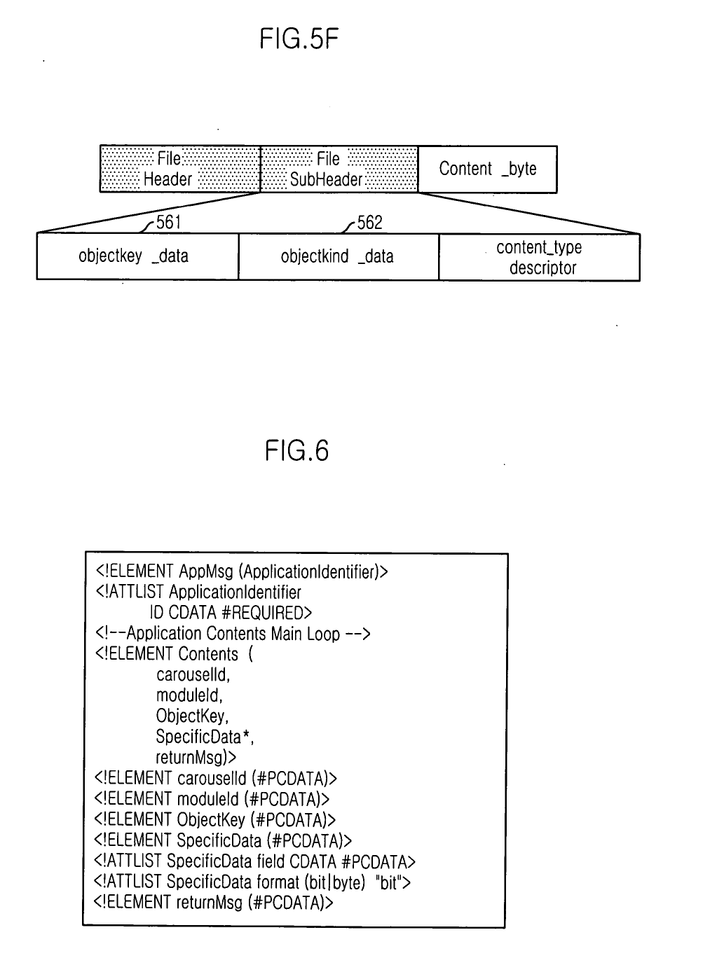

FIG. 6 is Document Type Definition (DTD) syntax for analyzing a message in an application layer in accordance with the present invention.

As described in FIG. 6, the objects of an actual content are identified based on the carouselId, moduleId, and ObjectKey. This structure can identify each object for the content whatever kind of messages is inputted through the return channel. A message of an actually corresponding object can be defined through a SpecificData field.

Herein, the SpecificData field can be defined specifically with no restriction on the number of application messages of the content. The specific field includes a field, a format and values thereof. The application message of the content received through the return channel is defined in a ReturnMsg file. The return channel message processor 21 of the data server unit 23 makes it possible to provide the interactive data broadcasting service by updating the content in real-time from an extensive Markup Language (XML) syntax having a structure and information of FIG. 6.

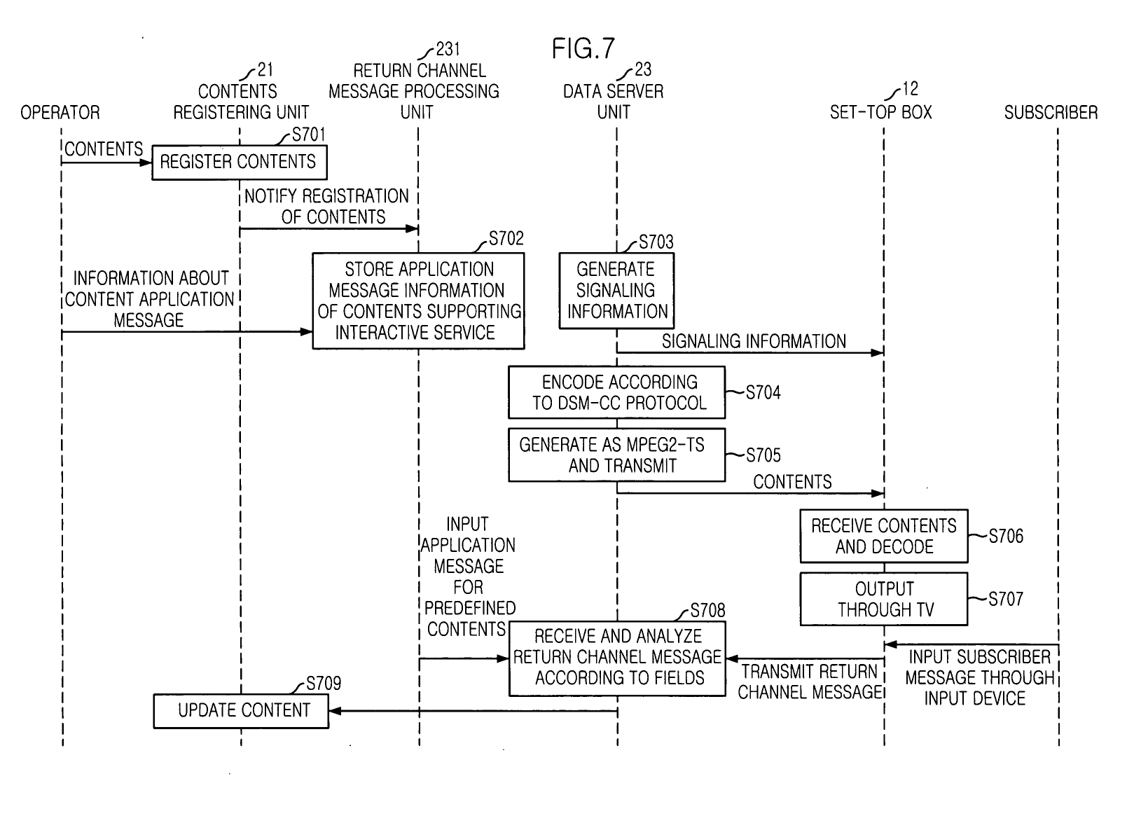

FIG. 7 is a flowchart describing a process of updating a content in real-time in the interactive data broadcasting service in accordance with an embodiment of the present invention.

To help understanding, it is assumed that there is a real-time auction program as an example of the interactive data broadcasting service. According to the broadcasting program, a user who watches the program on TV and offers the highest amount during a period can make a successful bid.

First, at step S701, the contents registering unit 21 registers a content of a data broadcasting service in the file system.

Then, signaling information of the content is stored in the database 22. When the content supports the interactive data broadcasting service, the registration of the content is informed to the return channel message processor 231 of the data server unit 23.

Then, if the content supports the interactive data broadcasting service, at step S702, the return channel message processor 231 stores contents application message information, i.e., signaling information.

Since the operator checks whether the content supports the interactive data broadcasting service, the return channel message processor 231 of the data server unit 23 stores the content application message in the data server unit in an XML syntax to conform to the DTD. That is, at steps S703 to S705, the content including the application is encoded into object carousel, data carousel, and MPEG2-TS packets and transmitted through the in-band channel 202, and the signaling information of the application is transmitted to the set-top box 12. When the application is a bound application, the signaling information is transmitted through the in-band channel 202, and when the application is an unbound application, the signaling information is transmitted through the out-of-band channel 201.

Accordingly, at steps S706 and S707, the message transmitted to the set-top box 12 goes through MPEG2-TS decoding, DSM-CC data carousel processing, and DSM-CC object carousel processing and then outputted on the TV screen.

Herein, if each subscriber input a specific amount on an auction item, which is subscriber message inputted through input devices, through the set-top box 12, the set-top box 12 transmits the return channel message to the data server unit 23 through the out-of-band channel 202.

Subsequently, at steps S708 and S709, the data server unit 23 updates the content in real-time by analyzing the return channel message received based on the application message for the content which is predefined in the return channel message processor 231 according to each field. To be more specific, FIG. 3 shows a network interface defined in the American National Standards Institute (ANSI)/Society of Cable Telecommunications Engineers (SCTE) 40. The application message transmitted through the return channel is loaded on the payloads 301 and 302 in FIG. 3. The format of the message loaded on the payloads can be different according to each content provider. Therefore, the present invention suggests a technology that can provide the real-time interactive data broadcasting service by analyzing the message transmitted through the return channel to provide the interactive data broadcasting service contents from diverse contents providers while using conventional subscriber devices.

As described above, according to the present invention, broadcasting businesses can broadcast contents provided from diverse contents providers to provide interactive data broadcasting. The data server 11 can provide the interactive data broadcasting service by receiving and analyzing the message inputted through the return channel.

In other words, the present invention achieves the object by encoding contents based on the DSM-CC protocol and including a mechanism for processing the return channel message in the data server on the transmitting part. Thus, the present invention can provide the data broadcasting service in real-time by defining an application message for identifying contents and defining the structure of the defined message data in advance, and analyzing the message transmitted from the subscriber through the return channel.

The method of the present invention can be realized as a program and stored in a computer-readable recording medium, such as CD-ROM, RAM, ROM, floppy disks, hard disks, and magneto-optical disks. Since this process can be easily implemented by those or ordinary skill in the art further description on it will not be provided herein.

The method of the present invention can provide the data broadcasting service in real-time by processing the messages inputted through the return channel based on each content.

Therefore, the technology of the present invention can provide broadcasting businesses with a variety of interactive data broadcasting services and subscribers with broadcasting services where they can participate enjoyably, instead of simply watching the TV.

The present application contains subject matter related to Korean patent application No. 10-2004-0105004, filed in the Korean Intellectual Property Office on Dec. 13, 2004, the entire contents of which is incorporated herein by reference.

While the present invention has been described with respect to certain preferred embodiments, it will be apparent to those skilled in the art that various changes and modifications may be made without departing from the scope of the invention as defined in the following claims.

What is claimed is:

1. A data server for interactive data broadcasting service, comprising:
a contents registering means for registering a content of data broadcasting service in a file system;
a storing means for managing and storing signaling information of the registered content; and
a data processing means for defining an application message for the content supporting an interactive service, identifying the kind of the content by receiving the message inputted through a return channel, updating the content by analyzing the inputted message based on structural information of the message to perform interactive data broadcasting service in real-time.

2. The data server as recited in claim 1, wherein the data processing means identifies the kind of the content based on a unique value of application, and the application is categorized as bound application which is transmitted through an in-band channel and as unbound application transmitted through an out-of-band channel.

3. The data server as recited in claim 1, wherein the content is encoded into object carousel, data carousel and Moving Picture Experts Group (MPEG) 2-Transmit Stream (TS) packets and transmitted through the in-band channel,
wherein the object carousel generates the content registered in the file system on a basis of object messages, which include Directory, File, Stream, StreamEvent, and ServiceGateWay object messages, forms the objects into modules based on the data carousel, and divides the modules into Download Data Block (DDB) messages, and
wherein the DDB messages are encoded into Digital Storage Media-Command and Control (DSM-CC) sections along with Download Service Initiate (DSI) and Download Information Indication (DII), which are control information for downloading the DDB messages, and positioned in payloads of the MPEG2-TS packets.

4. The data server as recited in claim 1, wherein the data processing means includes:
a return channel message processor for registering definition of a return channel message;
an encoder for defining the return channel message to satisfy transmission protocol and be encoded; and
a transmitter for transmitting subscriber data reflecting intention of a subscriber through the return channel by receiving a file structure and contents of the content from the set-top box.

5. The data server as recited in claim 1, wherein the return channel message processor determines whether the content supports interactive service, includes a structure of Document Type Definition (DTD) that defines formats for ech field of an application message based on whether the content supports interactive service, identifies objects of an actual content based on carouselId, moduleIdd, and ObjectKey, specifically defines messages of the actual object through SpecificData field, defines the SpecificData field without restriction on the number of application messages of the content, and forms the specific field with field, format and values thereof; and the application message of the content defines the message received through the return channel in a returnMsg field.

6. The data server as recited in claim 5, wherein the objects are updated in real-time by comparing the message inputted through the return channel with a predefined message format and identifying the message based on carouselId, moduleId, and ObjectKey to thereby update the broadcasting content in real-time.

7. A method for providing an interactive data broadcasting service, comprising the steps of:
a) registering a content of a data broadcasting service in a file system upon a request from an operator;
b) storing signaling information on the content in a database;
c) informing a data server to register the content supporting the interactive data broadcasting service;
d) registering definition of a return channel message in the data server;
e) defining the return channel message to satisfy transmission protocol and be encoded;
f) receiving a file structure and contents of the content from a subscriber device;
g) transmitting subscriber data reflecting intention of a subscriber through the return channel; and
h) updating the content by receiving and analyzing the return channel message transmitted from each subscriber on a field basis.

8. The method as recited in claim 7, wherein the content is encoded into object carousel, data carousel and Moving Picture Experts Group (MPEG) 2-Transmit Stream (TS) packets and transmitted through the in-band channel,
wherein the object carousel generates the content registered in the file system on a basis of object messages, which include Directory, File, Stream, StreamEvent, and ServiceGateWay object messages, forms the objects into modules based on the data carousel, and divides the modules into Download Data Block (DDB) messages, and
wherein the DDB messages are encoded into Digital Storage Media-Command and Control (DSM-CC) sections along with Download Service Initiate (DSI) and Download Information Indication (DII), which are control information for downloading the DDB messages, and positioned in payloads of the MPEG2-TS packets.

9. The method as recited in claim 7, wherein the data server determines whether the content supports interactive service, includes a structure of Document Type Definition (DTD) that defines formats for each field of an application message based on whether the content supports interactive service, identifies objects of an actual content based on carouselId, moduleId, and ObjectKey, specifically defines messages of the actual object through SpecificData field, defines the SpecificData field without restriction on the number of application messages of the content, and forms the specific field with field, format and values thereof; and the application message of the content defines the message received through the return channel in a returnMsg field through a return channel message processor.

10. The method as recited in claim 7, wherein the objects are updated in real-time by comparing the message inputted through the return channel with a predefined message format and identifying the message based on carouselId, moduleId, and ObjectKey to thereby update the broadcasting content in real-time.
